(19) United States
(12) Patent Application Publication
(10) Pub. No.: US 2004/0160500 A1
(43) Pub. Date: Aug. 19, 2004

(54) Ink set for ink jet printing, and ink jet printing method and printed matter using same

(75) Inventors: Yoshikatsu Itoh, Fukui (JP); Tomoyuki Nishikawa, Fukui (JP)

Correspondence Address: ROCCO S. BARRESE, ESQ., DILWORTH & BARRESE, LLP, 333 Earle Ovington Blvd., Uniondale, NY, 11553, US

(73) Assignee: SEIREN CO., LTD.

(21) Appl. No.: 10/776,365

(22) Filed: Feb. 11, 2004

(30) Foreign Application Priority Data
Feb. 12, 2003 (JP) 2003-33066

(51) Int. Cl. G01D 11/00

(52) U.S. Cl. 347/100

(57) ABSTRACT

An ink set for ink jet printing, as well as an ink jet printing method and a printed matter both using the ink set, are provided, the ink set permitting the formation of an image superior in clearness, not undergoing discoloration or decoloration even during baking, capable of including representation of intermediate colors and having a wide color region. In the ink set, inorganic pigments of two colors are used as red components and specific inorganic pigments of other colors are selected, and by using the ink set there is obtained an image superior in clearness and very superior in gradation and having a wide color region, and intermediate colors can be represented without discoloration or decoloration even after baking.

### FIELD OF THE INVENTION

The present invention relates to an ink set for ink jet printing using inorganic pigments as colorants, as well as an ink jet printing method and a printed matter both using the ink set. More particularly, the present invention is concerned with an ink set for ink jet printing using inorganic pigments superior in light resistance, clearness and gradation, capable of making color representation over a wide color region and capable of making coloration without making limitation to any specific base material.

### BACKGROUND OF THE INVENTION

Heretofore, when coloring such an inorganic base material as a ceramic or metallic material, importance has been attached to heat resistance, stability and light resistance, and from this standpoint there has mainly been adopted a method using inorganic pigments and fixing by baking.

In this field, with the recent tendency to upgrading of design, various studies have been made about color variation of inorganic pigments and many intermediate colors [colors other than the three primary colors (red, blue, yellow) and black] covering a wide color region have been proposed.

In principle, these intermediate colors are proposed not as color mixtures but as colors of inorganic pigments themselves. This is because mixing of inorganic pigments may cause decoloration or discoloration under certain conditions such as baking temperature.

The reason why such decoloration or discoloration occurs is presumed to be because if plural inorganic pigments are baked at once, the inorganic pigments induce an interaction, resulting in the crystal structure being changed.

Therefore, in case of using colorants different in baking temperature, it is necessary to perform baking steps in a plural number of times, with consequent deterioration of color reproducibility.

As a method for solving the above-mentioned problem, in JP 60-234899A there is disclosed a method wherein, in order to enhance the color reproducibility, a specific inorganic pigment is colored by cyan, yellow, magenta, and black in this order, thereby permitting a single baking step and affording coloration superior in color reproducibility.

In the above method, although the color reproducibility is superior, if the coloring order is different, an expected intermediate color is not obtained and there is a fear that decoloration or discoloration may occur. Thus, the above method is deficient in usefulness.

Besides, even the above method is a hand-writing method, so it is less industrially applicable and such special coloration as gradation cannot be effected as a matter of course.

On the other hand, in the printing industry, ink jet printing now attracts attention of many concerns. The reason is that colorful representations can be done in a small lot and a short period and it is also possible to effect industrial production.

Accordingly, there now exists a demand for a technique utilizing ink jet printing and applying inorganic pigments to a base material in the form of ink jets.

However, in using inorganic pigments in the form of ink jets, various problems have arisen due to its peculiarity, and such a mode of use has not been put to practical application even at present.

One primary cause is as follows. In ink printing, intermediate colors are represented by mixing of inks on a base material, so it is necessary to perform baking in a mixed state of inorganic pigments, and as a result there is a fear that there may occur such problems as decoloration or discoloration.

Further, in the representation of a red color component, because of properties of inorganic pigments, even in case of using an inorganic pigment alone, the color expression is poor or not clear, and particularly in case of forming an image, a red color component gives a weak impression and it is impossible to obtain a high-grade feeling.

As prior art literatures using inorganic pigments in ink jet printing there are cited JP 2001-55530A and JP 2001-81363A. In the former, discharge stability in ink jet printing is ensured by adjusting an average particle diameter of inorganic pigments and preventing precipitation, while in the latter, discharge stability and adhesion are improved by adding a dispersant, a solvent, glass frit and a defoaming agent to a specific pigment.

In both methods, however, improvement of discharge stability is intended and there is found no description related to color representation peculiar to ink jet printing. That is, it is difficult to represent intermediate colors and the advantage of ink jet printing, i.e., capability of representing such a design as gradation and a wide color region, cannot be exhibited effectively.

A prior art capable of solving such problems has not been established yet and there now exists a demand for effectively utilization of inorganic pigments in ink jet printing.

### SUMMARY OF THE INVENTION

The present invention solves the above-mentioned problems. More particularly, it is an object of the present invention to provide an ink set for ink jet printing capable of affording an image superior in clearness, not undergoing decoloration or discoloration during baking, permitting representation of intermediate colors and having a wider color region, as well as an ink jet printing method and a printed matter both using the ink set.

Having made earnest efforts for solving the foregoing problems, the present inventors found out that by using, as an ink set, two colors of inorganic pigments as red color components and specific inorganic pigments as other colors, there is obtained an image superior in clearness, having a wide color region and very superior in gradation, and that even after baking, it is possible to represent intermediate colors without decoloration or discoloration.

More specifically, the present invention resides in an ink set for ink jet printing using inorganic pigments as colorants, wherein a red color component of the ink set contains at least colors of inks which are magenta ink of gold purple and red ink of cadmium red.

The present invention also resides in an ink set for ink jet printing comprising inks which employ inorganic pigments as colorants and which are at least four colors of inks including magenta ink of gold purple and red ink of cadmium red, as red color components, as well as yellow ink and cyan ink.

Preferably, the yellow ink is cadmium yellow ink and the cyan ink is cobalt aluminum chrome blue ink.

The present invention further resides in an ink set for ink jet printing comprising inks which employ inorganic pigments as colorants and which are at least five colors of inks including magenta ink of gold purple and red ink of cadmium red, as red color components, as well as yellow ink of cadmium yellow, cyan ink of cobalt aluminum chrome blue, and black ink.

Preferably, the black ink is cobalt ferrite black ink.

The present invention further resides in an ink jet printing method wherein, using the ink set, an image is formed by ink jet on a base material, followed by baking.

Preferably, the base material is an inorganic material and an ink receptor layer is formed using glass frit on the surface of the base material prior to ink jet recording.

Preferably, after an image is formed by ink jet on the base material, all of inorganic pigments used are baked simultaneously to the base material by a single baking operation.

The present invention still further resides in a printed matter obtained by the above printing method.

### DETAILED DESCRIPTION OF THE INVENTION

The present invention will be described in more detail hereinunder.

Colorants used in the present invention are inorganic pigments, more specifically, metals, metal oxides or metal salts.

These are stable to heat and light, but their structures are poor in color expression and are apt to decompose by oxidation and reduction.

Therefore, in ink jet printing using inorganic pigments, the color range is generally narrow and particularly a red color component is weak, so in the present invention both magenta ink and red ink are used to widen the color region of red color and permit representation of intermediate colors.

To be more specific, in the ink set according to the present invention it is required that at least two colors of inks which are magenta ink of gold purple and red ink of cadmium red be contained.

In the cadmium red as referred to herein there also is included zirconium silicate cadmium inclusion red coated with zirconium silicate.

The red ink as referred to herein indicates an ink wherein the hue in case of the ink being baked is in the range of 10° to 50° counterclockwise assuming that a* axis (+) is 00 in a*b* space coordinates of CIEL*a*b* isochromatic color space. Likewise, the magenta ink indicates an ink lying in ranges of 0° to 10° and 330° to 360°. However, since color saturation gradually decreases toward the origin and approaches black, the distance from the original should be 10 or more in terms of saturation.

This is because the ink comprising both magenta ink and red ink widens the color region of red color which is weak in color expression, and affords an appropriate intermediate color when mixed with other colors (such as yellow or cyan).

For example, if orange color is to be represented, both yellow ink and red ink are discharged, while if purple is to be represented, both magenta ink and cyan ink are discharged, then mixed on a base material, whereby a clear intermediate color can be represented.

Even if yellow ink and magenta ink are mixed together, a clear orange color cannot be obtained, and even by mixing both red ink and cyan ink it is impossible to obtain a clear purple color.

The reason why gold purple and cadmium red are used as magenta and red, respectively, is that the color after baking is superior in color clearness and density and thus the use thereof is suitable for the ink jet printing method. As another reason, even when these two colors, or one of them, and another inorganic pigment are baked in a superimposed state of ink dots, they exhibit a relatively stable property difficult to induce an interaction.

Preferably, the ink set further contains yellow ink and cyan ink in addition to magenta ink and red ink. This is because it is generally intended to represent a color region suitable for an ink jet printing method wherein an image is formed in full color. By including the above four colors in the ink set it becomes possible to represent any desired intermediate color.

More specifically, as examples of inorganic pigments employable as yellow pigments there are mentioned lead antimony yellow, chrome yellow 10G, yellow 5G, chrome yellow G, chrome yellow, cadmium yellow, yellow iron oxide, enriched yellow iron oxide, yellow ocher, titanium yellow, titanium barium nickel yellow, vanadium tin yellow, vanadium zirconium yellow, praseodymium yellow, chrome titanium yellow, antimony titanium chrome yellow, and antimony titanium yellow, with cadmium yellow being particularly preferred.

In the cadmium yellow as referred to herein there also is included a composite salt of cadmium sulfide and zinc sulfide, a composite salt of cadmium sulfide and barrium salfate, a composite salt of cadmium sulfide, zinc sulfide and barrium sulfate and zirconium silicate cadmium inclusion yellow obtained by coating cadmium sulfide with zirconium silicate and the like.

As examples of inorganic pigments employable as cyan there are mentioned prussian blue, cobalt blue, ultramarine, cerulean blue, and cobalt aluminum chrome blue, with cobalt aluminum chrome blue being particularly preferred.

Even when these inorganic pigments are mixed with gold purple of magenta ink or cadmium red of red ink, followed by baking, intermediate colors can be represented without giving rise to the problem of decoloration or discoloration at the baking temperature and in a wider color region than in the prior art.

More preferably, the ink set further contains black ink in addition to magenta ink, red ink, yellow ink and cyan ink.

This is for the following reason. Generally black is obtained by mixing yellow, magenta and cyan, but even a slight difference in proportion causes a change in hue, so if black ink is contained as a single color, it is possible to solve the said problem and obtain a stable colored matter.

As concrete examples of inorganic pigments employable as black there are mentioned lamp black, furnace black, charcoal black, ivory black, graphite, iron black, manganese ferrite black, cobalt ferrite black, copper chrome black, and copper chrome manganese black, with cobalt ferrite black being particularly preferred. The reason why these pigments are preferred is that even when mixed with other colors, followed by baking, there occurs neither decoloration nor discoloration.

Other white, green, metallic and pearl inks may also be contained in the ink set. This is because the larger the number of colors, the more delicate color difference can be adjusted and the finer representations can be effected. However, they should be used optionally because there will be an influence on the preparation of ink, the number of ink jet heads and the ink jet printing time for example.

As concrete examples of inorganic pigments employable as white there are mentioned lead white, flowers of zinc, lithopone, titanium dioxide (anatase type), titanium dioxide (rutile type), zinc sulfide, antimony oxide, precipitated calcium carbonate, heavy calcium carbonate, kaolin, mica, precipitated barium sulfate, barite powder, gloss white, alumina white, talc, silica, calcium silicate, and cerium oxide. Concrete examples of inorganic pigments employable as green include chrome green, chromium oxide, viridian, cobalt green, cobalt chrome green, and titanium cobalt green. Concrete examples of inorganic pigments employable as metallic include aluminum powder, copper powder, lead powder, tin powder, and zinc powder. Concrete examples of inorganic pigments employable as pearl include mica titanium.

Glass frit may be added into inorganic pigment inks for the purpose of imparting adherence to the pigments. Glass frit contains silicon dioxide as a main component and an adjuvant is added thereto according to the purpose of use. As examples of employable adjuvants there are mentioned lithium carbonate, sodium carbonate, potassium carbonate, lead oxide, bismuth oxide, barium carbonate, strontium carbonate, calcium carbonate, magnesium carbonate, zinc oxide, aluminum oxide, aluminum hydroxide, boric acid, zirconium oxide, titanium oxide, and natural products such as feldspar, silica rock, borax, kaolin and mixtures thereof. These materials may be used each alone or as mixtures.

Not as a mixture of inorganic pigments and glass frit, but glass frit may be added to inorganic pigments in the stage of synthesis of the pigments (hereinafter referred to as “on-glaze color”).

As examples of mediums for dispersing the inorganic pigments, or both inorganic pigments and glass frit, or on-glaze color, in the ink composition used in the present invention, there are mentioned water, organic solvents, wax, and mixtures thereof, with no special limitation being made thereto.

In case of dispersing inorganic pigments, or both inorganic pigments and glass frit, or on-glaze color, into inks, there may be used as a dispersant any of various surfactants each alone or as a mixture.

As concrete examples of employable surfactants there are mentioned anionic surfactants such as fatty acid soap, sodium alkylsuccinate, sodium alkylbenzenesulfonate, sodium alkylnaphthalenesulfonate, sodium alkylsulfate, sodium polyoxyethylenealkylethersulfate, sodium dialkylsulfosuccinate, sodium alkylphosphate, styrene-maleic anhydride copolymer, olefin-maleic anhydride copolymer, polyacrylamide partial hydrolyzate, acrylamide-acrylate copolymer, and sodium alginate, cationic surfactants such as alkyltrimethyl ammonium chloride and alkyldimethylbenzyl ammonium chloride, nonionic surfactants such as polyoxyethylenealkyl ether, polyoxyethylenealkylallyl ether, and sorbitan fatty acid ester, and amphoteric surfactants such as alkylbetaine and amidobetaine. As anionic surfactants there may be used not only sodium salt but also any metal salts and ammonium salts.

If necessary, there may be added such additives as surface tension adjustor, viscosity modifier, specific resistance modifier, thermostabilizer, antioxidant, antireductant, antiseptic, pH adjustor, defoaming agent, and wetting agent.

Inorganic pigment inks can be obtained by mixing the above materials, dispersing the resulting mixtures with use of a dispersing machine such as, for example, roll mill, ball mill, colloid mill, jet mill, beads mill or, sand mill, and subsequent filtration.

Further, where required, a material having a liquid absorbing property may be provided as an ink receptor layer on the base material, whereby it is possible to prevent ink bleeding after discharge and impingement of ink against the base material.

Preferably, an ink receptor layer is formed using glass frit on the base material, whereby there is formed an image which is free of bleeding not only after printing but also after baking. Further, if unbaked glass frit is used as an ink receptor layer, inorganic pigments, glass frit contained in ink, and glass frit contained in the ink receptor layer, are melt-mixed, whereby it becomes possible to form a glass coating superior in adherence.

Thus, the glass frit used in the ink receptor layer may be the same as the foregoing glass frit which may be added to ink, or may be different from the foregoing glass frit, provided both are close to each other in softening point and expansion coefficient. This is because a marked difference would cause unsatisfactory adherence for example.

The amount of glass frit applied on drying is preferably in the range of 50 to 500 g/m². This is because if it is less than 50 g/m², it is impossible to fully prevent bleeding of ink, while if it exceeds 500 g/m², the glass frit layer after baking becomes too thick and the occurrence of crack may result.

It is preferable that the glass frit used as the ink receptor layer contain about 2% to 10% of cadmium in its components.

This is because by using such a cadmium-containing glass frit in the above ink combination, the color-developability of inorganic pigments after baking is improved remarkably.

An adhesive may be added if necessary to the ink receptor layer formed by glass frit according to the present invention. This is because the addition of an adhesive is effective in enhancing the working efficiency at the time of forming the ink receptor layer. Concrete examples of employable adhesives include natural polymers such as starch, natural gum, vegetable protein, seaweed, casein, and gelatin, semisynthetic polymers such as ether type cellulose, ester type cellulose, ether type starch, ester type starch, and processed natural gum, and synthetic polymers such as polyvinyl alcohol, polyethylene glycol, polyvinyl acetate, polyvinyl butyrate resin, polyvinyl acrylate resin, polyvinyl methyl resin, crosslinking type polyacrylic acid, sodium polyacrylate, polyacrylic acid ester, polyacrylamide, sodium methacrylate, polybutadiene, polyurethane, polyester, and polylactic acid.

Of course, additives such as dispersant, antioxidant, antireductant, and pH adjustor may be added if necessary.

As examples of base materials employable in the present invention there are mentioned ceramic materials such as glass, pottery, porcelain enamel, and tile, as well as metals, provided no special limitation is made thereto.

It is preferable that all of the inorganic pigments used be baked at a time. This is because if the baking is performed plural times, not only there arises a cost-related problem but also color variations result.

Generally, in the case of pottery, baking is performed at a temperature of 700° to 850° C. in an on-glaze method, 1100° to 1300° C. in an in-glaze method, for 30 to 60 minutes; in the case of glass, baking is performed at a temperature of 500° to 650° C. for 30 to 60 minutes; and in the case of porcelain enamel, baking is performed in a furnace heated in advance at a temperature of 750° to 850° C. for 1 to 2 minutes. Actually, however, the baking temperature and time are determined taking thermal deformation of the base material and the type of the furnace used into account.

In the case where baking is conducted at such a high temperature as 1100° to 1300° C., it is preferable to use inorganic pigments superior in heat resistance. Concrete examples include gold purple as magenta ink, zirconium silicate cadmium inclusion red as red ink, zirconium silicate cadmium inclusion yellow and praseodymium yellow as yellow inks, cobalt aluminum chrome blue as cyan ink, and cobalt ferrite black as black ink.

Also as the glass frit to be used there is selected one having appropriate thermal expansion coefficient and softening point. If there is a marked difference in thermal expansion coefficient and softening point between the base material and the glass frit both used, there is not attained a satisfactory adherence to the base material, causing bonding defect or crack. Therefore, attention should be paid to this point.

For example, in the case where the base material used in glass having a softening point of 600° C. or thereabouts, there is selected glass frit having a softening point equal to or lower than the base material softening temperature of 600° C. or thereabouts, and in the case of tile or pottery having a softening point of 800° C. or thereabouts, there is selected glass frit having a softening point equal to or lower than 800° C. or thereabouts.

As the ink jet printing method there may be adopted, for example, any of such continuous methods as charging modulation method, microdot method, charging injection control method, and ink mist method, and such on-demand methods as stemme method, pulse jet method, bubble jet (registered trademark) method, and electrostatic suction method.

Working examples of the present invention will be described below, but it is to be understood that the invention is not limited thereto.

### EXAMPLE 1

Ink was used for each of the following pigments in accordance with the following formulation, followed by dispersion using a ball mill and subsequent filtration to remove impurities, affording a uniform, inorganic pigment ink.

[Ink Formulation]

| Inorganic pigment | x | wt % |
|---|---|---|
| Frit: 12-3567 (containing lead, transparent, | 10 | wt % |
| a product of Ferro Enamels (Japan) Limited) | | |
| Dispersant: CARRYBON B (a polycaroboxylic | 1 | wt % |
| acid type surface active agent, a product | | |
| of Sanyo Chemical Industries, Ltd.) | | |
| Wetting agent: Polyethylene Glycol 400 | 10 | wt % |
| (a product of NOF CORPORATION) | | |
| Pure water | balance | |
| Total | 100 | wt % |

<<Inorganic Pigments>>

| | | | | |
|---|---|---|---|---|
| Y | (Yellow) | Cadmium Yellow | 10 | wt % |
| M | (Magenta) | Gold Purple | 2 | wt % |
| C | (Cyan) | Cobalt Aluminum Chrome Blue | 10 | wt % |
| R | (Red) | Cadmium Red | 10 | wt % |
| K | (Black) | Cobalt Ferrite Black | 10 | wt % |

Next, an ink receptor layer was formed by the following method.

[Formulation of Ink Receptor Layer]

| Glass Frit 32117 | 65 | wt % |
|---|---|---|
| (Glass flux containing cadmium, a product | | |
| of Izawa Pigments Co.) | | |
| Polyvinyl alcohol (adhesive, PVA-110, a | 5 | wt % |
| product of Kuraray Co.) | | |
| Pure water | balance | |
| Total | 100 | wt % |

Glass frit 32117 was dry-dispersed using a ball mill. Then, polyvinyl alcohol and pure water were added and kneaded with a mortar, followed by coating onto a tile (pottery, glazing) using a screen and subsequent drying at 110° C. for 10 minutes to form an ink receptor layer on the base material.

For the tile thus formed with the ink receptor layer, printing was performed using the ink prepared above and an ink jet printer under the following conditions, followed by baking at 800° C. for 45 minutes using an electric furnace for ceramic art:

[Printing Conditions]

| | | | |
|---|---|---|---|
| a) | Nozzle dia.: | 70 | (μm) |
| b) | Applied voltage: | 50 | (V) |
| c) | Pulse width: | 20 | (μs) |
| d) | Drive frequency: | 1 | (kHz) |
| e) | Resolution: | 180 | (dpi) |

| | | |
|---|---|---|
| f) | Evaluation pattern: | 3 cm × 3 cm matrix |

[Evaluation Contents]

The resulting printed matter was evaluated in the following manner.

(1) Clearness

The color of the printed matter was checked visually.

∘: The color is represented clearly without impairing the pigment color.

Δ: The pigment color is somewhat darkish and somewhat deficient in clearness.

x: Color is markedly darkish and not clear.

Evaluation Ink (a Single Color)

Printing ink: M, R (two colors in total)

Amount of ink applied: 10 nl/mm²

The results of evaluation are shown in Table 1.

(2) Discoloration Feeling

The printed matter was checked for color visually.

∘: Neither discoloration nor decoloration was recognized in the color of the evaluation pattern, but a desirable intermediate color was recognized.

Δ: The color of the evaluation pattern is somewhat discolored or decolored.

x: The color of the evaluation pattern is clearly discolored or decolored.

Evaluation Ink (Mixed Color)

Printing ink: Y+R, Y+M, M+R, R+C, M+C (five sets in total)

Amount of ink applied: 10 nl/mm²

The results of evaluation are shown in Table 2.

(3) Intermediate Color Representation

The color of the printed matter was checked visually to determine whether such intermediate colors as orange, purple and green are represented or not.

∘: Intermediate colors are represented in high density and high saturation.

Δ: Intermediate colors are represented, but the saturation is somewhat low and the color is somewhat darkish.

x: The saturation of intermediate colors is low and the colors are very darkish, so that the color representation is poor.

Evaluation Ink (intermediate colors)

Orange color printing ink: (e.g., Y+R, Y+M)

Purple color printing ink: (e.g., R+C, M+C)

Green color printing ink: (e.g., Y+C, G)

Amount of ink applied: 5, 10, 20, 40 nl/mm² (4×4 modes in total)

The results of evaluation are shown in Table 2.

(4) Pattern Representation

Pattern Preparation (JIS-X9201 N3 Image)

Printing ink: all of the inks described in the working Examples

The results of evaluation are shown in Table 2.

### EXAMPLE 2

Printed matter was prepared and evaluated in the same way as in Example 1 except that Y of ink used was substituted by praseodymium yellow.

| | |
|---|---|
| Y (yellow) praseodymium yellow | 10 wt % |

Printed matter was prepared and evaluated in the same way as in Example 1 except that there were used six colors of inks of Y, M, R, C, G (green), and K and the following inorganic pigment was used as green:

| | |
|---|---|
| G (green) titanium cobalt green | 10 wt % |

### COMPARATIVE EXAMPLE 1

Printed matter was prepared and evaluated in the same way as in Example 1 except that the red component in inorganic pigments used was changed to magenta ink alone.

### COMPARATIVE EXAMPLE 2

The same procedure as in Example 1 was repeated except that chrome tin pink and red iron oxide were used as magenta ink and red ink, respectively.

TABLE 1

| | Ex. 1 | | Ex. 2 | | Ex. 3 | | Com. Ex. 1 | | Com. Ex. 2 | |
|---|---|---|---|---|---|---|---|---|---|---|
| Color | M | R | M | R | M | R | M | R | M | R |
| Clearness | ◯ | ◯ | ◯ | ◯ | ◯ | ◯ | ◯ | — | Δ | Δ |

TABLE 2

| | Ex. 1 | Ex. 2 | Ex. 3 | Com. Ex. 1 | Com. Ex. 2 |
|---|---|---|---|---|---|
| Discoloration | ◯ | ◯ | ◯ | ◯ | X |
| Feeling | | | | | |
| Orange | ◯ | ◯-Δ | ◯ | X | X |
| Representation | | | | | |
| Purple | ◯ | ◯ | ◯ | ◯ | X |
| Representation | | | | | |
| Green | Δ | Δ | ◯ | Δ | Δ |
| Representation | | | | | |
| Pattern | ◯ | ◯-Δ | ◯ | Δ | X |
| Representation | | | | | |

As is apparent from Tables 1 and 2, the ink jet printed matters of Examples 1 to 3 obtained by using ink jet printing ink sets according to the present invention permits clear color representations and have each a wide color region without discoloration or decoloration of intermediate color representations. Also in case of forming images, the printed matters exhibit a sufficient high-grade impression. Particularly, by specifying Y, M, R, and C as in Examples 1 and 3, there can be obtained printed matters superior also in the saturation of intermediate colors.

As set forth above, the ink jet printing ink sets according to the present invention permits color representation superior in clearness and in a wide color region without discoloration or decoloration and permits coloration without making limitation to any specific base material. Further, high quality conditions peculiar to ink jet printing such as density and image quality can be fully satisfied and therefore it is possible to provide an ink jet printed matter using inorganic pigments correspondingly to the recent improvement of design power.

What is claimed is:

1. An ink set for ink jet printing, comprising inks of inorganic pigments as colorants, characterized in that a red color component of the ink set contains at least two color inks which are magenta ink of gold purple and red ink of cadmium red.

2. An ink set for ink jet printing, comprising at least four color inks of inorganic pigments as colorants which are magenta ink of gold purple and red ink of cadmium red as red components, as well as yellow ink and cyan ink.

3. An ink set for ink jet printing according to claim 2, wherein said yellow ink is cadmium yellow ink and said cyan ink is cobalt aluminum chrome blue ink.

4. An ink set for ink jet printing, comprising at least five color inks of inorganic pigments as colorants which are magenta ink of gold purple and red ink of cadmium red as red components, as well as yellow ink of cadmium yellow, cyan ink of cobalt aluminum chrome blue, and black ink.

5. An ink set for ink jet printing according to claim 4, wherein said black ink is cobalt ferrite black ink.

6. An ink jet printing method which comprises performing printing for a base material using an ink jet of the ink set described in claim 1 to form an image on the base material and thereafter performing baking.

7. An ink jet printing method according to claim 6, wherein said base material is an inorganic material and an ink receptor layer is formed using glass frit on a surface of the base material prior to inkjet recording.

8. An ink jet printing method according to claim 6 or claim 7, wherein after the printing and image formation for said base material using an ink jet, all of the inorganic pigments are baked simultaneously to the base material by a single baking operation.

9. A printed matter obtained by the method of claim 6.
